(19) United States
(12) Patent Application Publication
(10) Pub. No.: US 2009/0066496 A1
(43) Pub. Date: Mar. 12, 2009

(54) LOW FREQUENCY RECEIVER FOR A TIRE PRESSURE MONITOR SYSTEM

(75) Inventors: John S. Nantz, Brighton, MI (US); Keith E. Mattson, Livonia, MI (US); Kevin Cotton, Fenton, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/853,367

(22) Filed: Sep. 11, 2007

(51) Int. Cl. B60C 23/00

(52) U.S. Cl. 340/442

(57) ABSTRACT

A tire pressure monitoring (TPM) system for a vehicle is provided. The system comprises a TPM receiver, a trigger device and a TPM sensor. The TPM receiver is adapted to receive tire pressure information. The trigger device is adapted to generate a low frequency (LF) unmodulated signal that is indicative of trigger command. The TPM sensor comprises an LF tank circuit adapted to receive the LF unmodulated signal and a microprocessor operably coupled to the LF tank circuit and configured to detect the presence of LF unmodulated signal and to transmit a LF output signal having tire pressure information to the TPM receiver in response to the trigger command without demodulating the LF unmodulated signal.

### TECHNICAL FIELD

The embodiments of the present invention described herein generally relate to a tire pressure monitoring (TPM) wheel sensor unit in a TPM system.

### BACKGROUND

Tire pressure monitor (TPM) sensors generally detect tire pressure information for tires on a vehicle. The TPM sensor transmits the tire pressure information as a radio frequency (RF) signal to a TPM receiver. The TPM receiver processes the tire pressure information and sends out tire pressure messages over a multiplexed bus protocol to an instrument cluster or any other electronic module in the vehicle. The instrument cluster or other electronic module provides the tire pressure status on a display for a user.

Each TPM sensor in the vehicle includes a low frequency (LF) receiver for receiving a plurality of modulated LF messages. Original Equipment Manufacturers (OEM) generally require that the TPM sensors are configured to respond to the plurality of modulated LF messages for diagnostic testing and/or operational purposes. Additional circuitry and software has to be added to the TPM sensor to ensure that the TPM sensor has the capability to respond to all of the modulated LF messages. For example, each TPM sensor may need additional circuitry and software for demodulating and decoding modulated data in the LF messages. In some cases, the TPM sensor throughout its life span, may seldom be required to respond to all of the modulated LF messages as set forth by the OEMs. Some of the modulated LF messages may be rarely used or not used at all.

Each TPM sensor also includes a microcontroller and an over-voltage protection circuit. The microcontroller and the over-voltage protection circuit are implemented as an application specific integrated circuit (ASIC). The ASIC is a customized circuit that may simplify circuit board design and reduce manufacturing costs. The LF receiver may be integrated into the ASIC design or implemented as a standalone circuit. While ASIC designs may reduce manufacturing costs, the costs savings may be offset due to fabrication costs associated in producing an ASIC for a specific application.

Accordingly, it would be desirable to provide a TPM sensor that is inexpensive to develop and supports predetermined diagnostic, testing and operational requirements as set forth by OEMs.

### SUMMARY

In one embodiment, a tire pressure monitoring (TPM) system for a vehicle is provided. The system comprises a TPM receiver, a trigger device and a TPM sensor. The TPM receiver is adapted to receive tire pressure information. The trigger device is adapted to generate a low frequency (LF) unmodulated signal that is indicative of trigger command. The TPM sensor comprises an LF tank circuit adapted to receive the LF unmodulated signal and a microprocessor operably coupled to the LF tank circuit and configured to detect the presence of LF unmodulated signal and to transmit a LF output signal having tire pressure information to the TPM receiver in response to the trigger command without demodulating the LF unmodulated signal.

In another embodiment, a tire pressure monitoring (TPM) sensor in a vehicle is provided. The TPM sensor is capable of communicating with a trigger device that generates a low frequency (LF) signal unmodulated signal that is indicative of a trigger command. The sensor comprises an LF tank circuit and a microprocessor. The LF tank circuit is adapted to receive the LF unmodulated signal. The microprocessor is operably coupled to the LF tank circuit and adapted to detect the presence of the LF unmodulated signal and to transmit an RF output signal having tire pressure information in response to the trigger command without demodulating the LF unmodulated signal.

A tire pressure monitoring (TPM) sensor in a vehicle is provided. The TPM sensor is capable of communicating with a trigger device that provides at least one low frequency (LF) modulated input signal. The sensor comprises an LF tank circuit, a microprocessor and a compare circuit. The LF tank circuit is adapted to receive the LF modulated input signal at a predetermined frequency. The microprocessor is operably coupled to the LF tank circuit and is adapted to demodulate the LF modulated input signal, to decode data present in the LF modulated input signal and to generate an LF output signal in response to the decoded data. The comparator is operably coupled to the LF tank circuit and is adapted to receive the LF modulated input signal and to provide the LF modulated input signal to the microprocessor in response to the comparator determining that the LF modulated input signal is a valid signal.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 depicts a TPM system in accordance to one embodiment of the present invention;

FIG. 2 depicts a block diagram of various components positioned within the TPM sensor;

FIG. 3 depicts a partial view of a TPM sensor in accordance to one embodiment of the present invention;

FIG. 4 depicts a partial view of a TPM sensor in accordance to another embodiment of the present invention; and

FIG. 5 depicts a low frequency modulation signal.

### DETAILED DESCRIPTION OF THE PREFERRED EMBODIMENT(S)

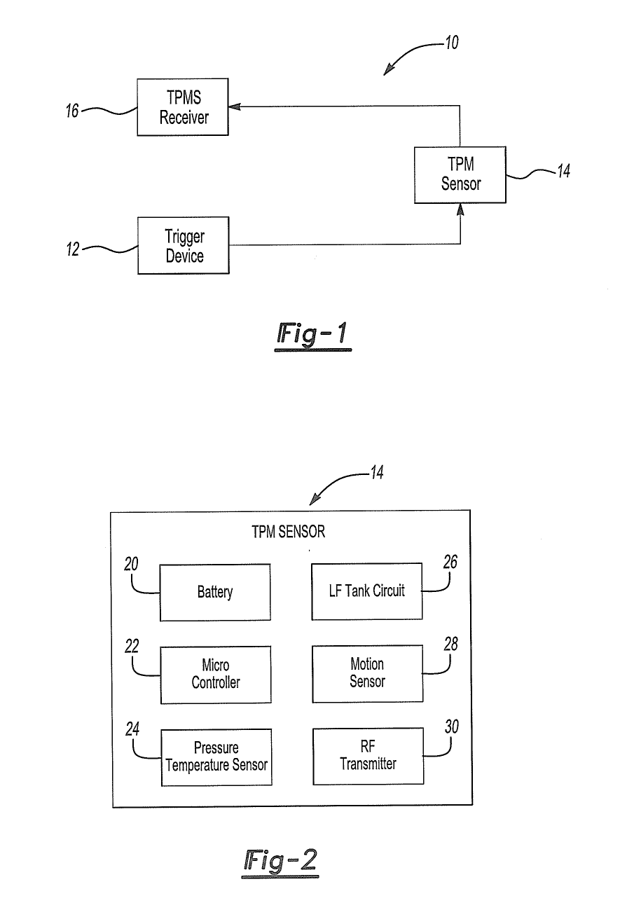

FIG. 1 depicts a tire pressure monitor (TPM) system 10 for use in a vehicle in accordance to one embodiment of the present invention. The system 10 comprises a trigger device 12, a TPM sensor 14 and a TPM receiver 16. While one TPM sensor 14 is shown in FIG. 1, the vehicle may include up to five TPM sensors (one extra TPM sensor for a spare tire). Each TPM 14 sensor may be positioned within a tire (not shown) for providing and not limited to pressure information for the tires, temperature information and battery power level information for the TPM sensor 14. The TPM sensor 14 may transmit the temperature, pressure, and battery information as RF output signals to the TPM receiver 16, periodically and/or on-demand. The TPM receiver 16 processes the RF output signals from the TPM sensor 14 and provides the pressure, temperature and battery information to an instrument cluster (not shown). The cluster provides the tire pressure, temperature and battery level information to a user via a message center or other suitable visual indicator in the vehicle.

The trigger device 12 may include any number of devices for generating a plurality of trigger commands. Such trigger commands (or trigger signals) are generally defined as messages or commands which require the TPM sensor 14 to perform a particular function. Such functions may be for operational, diagnostic and/or testing purposes. The trigger device 12 transmits the trigger commands as radio frequency (RF) modulated input signals. In one example, the RF modulated input signals may be low radio frequency (or low frequency) (LF) amplitude shift key (ASK) modulated onto an envelope of a carrier wave at a predetermined frequency. In one example, the predetermined LF frequency may be 125 kHz. The particular frequency, for the carrier wave may be varied based on the desired criteria of a particular implementation.

The trigger circuit 12 may include an initiator that is configured to trigger operation of the TPM sensor 12. The initiator is generally positioned within the vehicle. For example, during vehicle startup, the initiator may send the LF modulated input signal to a particular TPM sensor 14 in the vehicle to trigger the TPM sensor 14 into transmitting data to the TPM receiver 16 for a particular tire. Such a process may be exhibited when configuring a particular TPM sensor to a particular wheel so that the TPM receiver 16 has knowledge of which TPM sensor 14 is positioned within a particular wheel. The TPM receiver 16 may send multiplexed messages over a multiplex bus to the instrument cluster (or other module in the vehicle) to provide pressure and other information for a specific tire. Vehicles may or may not include an initiator. The implementation of the initiator on a vehicle may vary based on the type of vehicle used.

The trigger device 12 also comprise a number of diagnostic based hand held tools. For example, the trigger device 12 may be a diagnostic tool used by personnel in dealerships, vehicle assembly plants, or wheel supplier plants to communicate with the TPM sensor 14. The trigger device 12 may also be an end of line (EOL) tester that is used to test the integrity of the TPM sensor 14 during the assembly of the TPM sensor 14 or during the assembly of the vehicle.

The trigger device 12 (e.g., EOL tester or the hand held test tool) may transmit trigger signals as diagnostic commands in the form of the LF modulated input signals to the TPM sensor 14 and wait for a response from the TPM sensor 14 to confirm operational integrity. The trigger device 12 may also request that the TPM sensor 14 provide responses LF modulated input signals for diagnostic purposes. The responses may include that the TPM sensor 14 provide diagnostic information such as factory mode information, tool mode information, software revision-level, message data, preamble data and check sum information or other suitable diagnostic responses. The trigger device 12 may also request that the TPM sensor 14 transmit tire pressure information or other information on-demand as opposed to waiting for the next periodic event for the TPM sensor 14 to transmit the information.

FIG. 2 depicts a block diagram of various electrical components positioned within the TPM sensor 14. The TPM sensor 14 includes a battery 20 and a microcontroller 22. The battery 20 provides a power source for the microcontroller 22. The microcontroller 22 controls the function of the TPM sensor 14. The microcontroller 22 may be implemented as an ASIC. A pressure/temperature sensor 24 is integrated into the TPM sensor 14 and measures temperature and tire pressure. An LF tank circuit 26 (or LF receiver) receives the LF modulated input signals which generally correspond to the trigger signals. The TPM sensor 14 may employ a polling scheme to detect the LF modulated input signals to preserve battery life.

A motion sensor 28 is also integrated into the TPM sensor 14. The motion sensor 28 wakes up the microcontroller 22 as the tire starts to rotate. The TPM sensor 14 transmits data as RF output signal to the TPM receiver 16 in response to the tire rotating. The RF output signal may be a low RF output signal. The TPM sensor 14 provides tire pressure information and other information even after the key is out of the ignition (e.g., when the vehicle is in a sleep mode). The TPM sensor 14 provides the tire pressure information periodically while the vehicle is in the sleep mode. In one example, each periodic event may be minutes apart from each other to preserve battery life. An ASIC may be fabricated to include all of the components 20, 22, 24, 26, 28 and 30 or any one or more of the components 20, 22, 24, 26, 28 and 30.

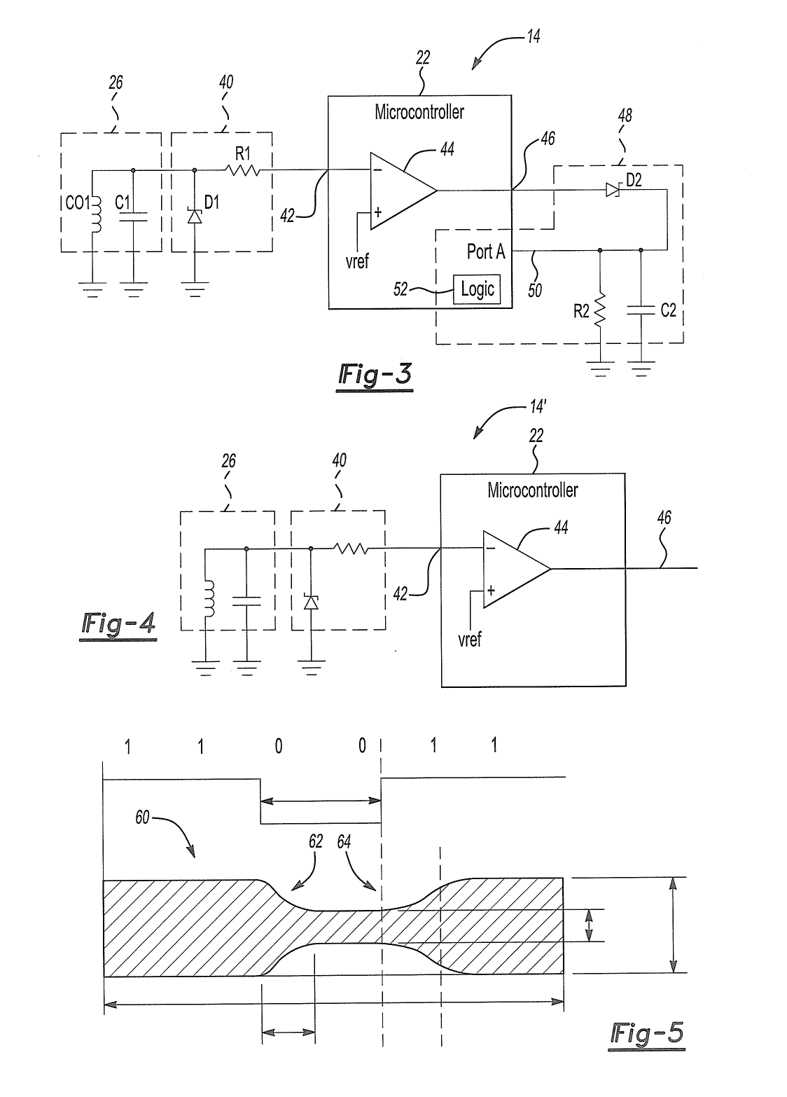

FIG. 3 depicts a partial schematic view of the TPM sensor 14 in accordance to one embodiment of the present invention. The LF tank circuit 26 is adapted to receive LF modulated input signals from the trigger device 12 (e.g., LF handheld devices, initiator, or other LF generation device). The LF tank circuit 26 includes a coil C01 and a capacitor C1. The coil C01 and capacitor C1 may be tuned such that the LF tank circuit 26 receives the LF modulated input signals at 125 kHz.

An over-voltage protection circuit 40 is coupled to the LF tank circuit 26. An input 42 of the microcontroller 22 is coupled to an output of the over-voltage protection circuit 40. The over-voltage protection circuit 42 includes a diode D1 and a resistor R1 to protect the microcontroller 22 in the event the LF tank circuit 26 receives a large voltage amplitude from an LF field present in the LF modulated input signal. Diode D1 limits the input voltage to the microcontroller 22. The diode D1 may be implemented as a Schottky diode. Resistor R1 limits the flow of current to the microcontroller 22.

The microcontroller 22 generally comprises an ASIC. The microprocessor 22 includes a compare circuit and a logic circuit 52. The compare circuit includes a comparator 44 or any other circuit configured to compare the voltage input (e.g., input to the microcontroller 22) to a predetermined voltage and to generate a voltage output based on the voltage input and the predetermined voltage. The input 42 is coupled directly to a negative input pin of the comparator 44. A positive input pin is coupled to voltage reference (Vref). Vref may be calibrated to a particular voltage via software. The particular voltage value of Vref may be varied based on the desired criteria of a particular implementation. The comparator 44 provides a voltage on an output pin 46.

An envelope detection circuit 48 is coupled to the output pin 46. The envelope detection circuit 46 includes a diode D2, a resistor R2, a capacitor C2 and the logic circuit 52 of the microcontroller 22. The diode D2 is adapted to clamp voltage on the output pin 46. In one example, diode D2 may be a Schottky diode. Resistor R2 and capacitor C2 form a low-pass filter to define a frequency window for allowing specified frequencies of the signal to pass to the logic circuit 52 via an output 50. Port pin on the microcontroller 22 receives the filtered signal from the low-pass filter. The low-pass filter and the logic circuit 52 coact with each other to demodulate and decode the LF modulated input signal.

In operation, the tank circuit 26 receives LF modulated signals from the trigger device 12. The data on the LF modulated input signal may be ASK modulated onto a carrier wave having a radio frequency of 125 KHz. The over-voltage protection circuit 40 protects the input 42 to the microcontroller 22 in the event the LF field in the input signal generates a large input voltage. The input voltage is presented to the negative input pin of the comparator 44. The comparator 44 compares the voltage of the negative input pin to Vref to ensure that the incoming voltage from the LF field is not noise. If the voltage at the negative input pin is larger than Vref, then the comparator 44 outputs a high voltage on the output pin 46. If the voltage at the positive pin is less then Vref, then the comparator 44 outputs a low voltage on the output pin 46. Vref is generally a calibratable value configured by software in the microcontroller 22. Conventional TPM sensors generally include operational amplifiers and filters to increase the amplitude of the LF field to ensure that the incoming LF field is not noise. The implementation of the comparator 44 provides for a low-cost alternative to such an approach, as the comparator 44 is able to detect the presence of a valid field by comparing the incoming voltage to a predetermined voltage without the need to increase the amplitude of the LF field.

The voltage output of the comparator 44 is passed through the low-pass filter where high value frequencies are filtered and low frequencies are passed to the microcontroller 22 via the Port pin. The microcontroller 22 demodulates and decodes data present in the LF modulated input signal.

While the microcontroller 22 is generally adapted to detect the presence of the LF field in the LF modulated input signal, the microcontroller 22 is not capable of reacting to the LF field alone. The microcontroller 22 and the envelope detection circuit 48 demodulates the modulated input signal and decodes data present within the LF modulated input signal in order for the TPM sensor 14 to transmit the RF output signal.

In general, the TPM sensor 14 is configured to decode a plurality of trigger commands transmitted as LF modulated input signals by the trigger device 12. The TPM sensor 14 may demodulate and decode the data in the LF modulated input signal and transmit a particular RF output signal in response to the data in the RF modulated input signal. The diagnostic commands modulated on the input signal may include but not limited to factory mode information requests, tool mode information requests and software mode information requests. The TPM sensor 14 may provide such information and other data related to operation of the TPM sensor 14.

FIG. 4 depicts a partial view of a TPMS sensor 14′ sensor in accordance to another embodiment of the present invention. The TPM sensor 14′ includes the microcontroller 22, the LF tank circuit 26, and the over-voltage protection circuit 40. The sensor 14′ is similar to the sensor 14 as illustrated in FIG. 3 with the exception of the envelope detection circuit 48. The sensor 14′ is adapted to act or transmit the RF output signal in response to simply detecting the presence of the LF field. In contrast, the sensor 14′ is adapted to detect the LF field, and demodulate and decode data prior to transmitting the RF output signal. The trigger device 12 as used in connection with the sensor 14′ may be configured to transmit the LF field at a predetermined frequency without data.

In operation, the tank circuit 26 receives the LF field at the corresponding frequency. The overvoltage protection circuit 40 protects the microcontroller 22 in the event voltage from the LF field is large. Resistor R1 limits the amount of current delivered to the microcontroller 22. Voltage from the LF field is presented to the negative pin of the comparator 44. The comparator 44 compares the voltage at the negative input pin to Vref to differentiate between a true voltage level or noise that may be present in the input signal. If the voltage at the negative input pin is larger than Vref, then the comparator 44 outputs a high voltage on the output pint 46. If the voltage at the positive pin is less then Vref, then the comparator 44 outputs a low voltage on the output pin 46. As noted in connection with FIG. 3, the implementation of the comparator 44 provides for a low cost and reliable alternative to using operational amplifiers and other such circuitry to increase the amplitude of the incoming LF field to differentiate between valid fields and noise.

A high output voltage on the output pin 46 may be indicative of a valid LF field. In response to detaching a valid LF field the sensor 14′ may transmit data on the RF output signal. Such data that may be transmitted on the LF output signal may include tire pressure information, sensor IDs, software revision levels, check sum data, temperature data, battery power level, preamble data and/or all diagnostic responses generally required by OEMs. The sensor 14′ may transmit all of the mentioned information and more on a single RF output signal.

The sensor 14′ provides a low-cost alternative in comparison to the sensor 14 as described in connection with FIG. 3. The sensor 14′ does not need additional circuitry to demodulate data since the sensor 14′ is adapted to respond to an LF unmodulated input signal by simply detecting the presence of a valid LF field. All pertinent data may be need to be transmitted by the sensor 14′ (e.g., diagnostic, testing and operational information) as a single LF based output signal in response to detecting the presence of the LF field.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A tire pressure monitoring (TPM) system for a vehicle, the system comprising:
a TPM receiver adapted to receive tire pressure information;
a trigger device adapted to generate a low frequency (LF) unmodulated signal that is indicative of trigger command; and
a TPM sensor comprising an LF tank circuit adapted to receive the LF unmodulated signal and a microprocessor operably coupled to the LF tank circuit and configured to detect the presence of the LF unmodulated signal and to transmit a LF output signal having tire pressure information to the TPM receiver in response to the trigger command without demodulating the LF unmodulated signal.

2. The system of claim 1 wherein the LF output signal further includes temperature and diagnostic information and the LF tank circuit is adapted to receive the LF unmodulated signal at a predetermined frequency.

3. The system of claim 1 wherein the microprocessor comprises an application specific integrated circuit (ASIC).

4. The system of claim 3 further comprising an over-voltage protection circuit positioned between the LF tank circuit and the microprocessor to protect the microprocessor from an over-voltage condition caused by the LF unmodulated signal.

5. The system of claim 4 wherein the over-voltage protection circuit comprises a diode to limit voltage from the LF unmodulated signal and a resistor coupled to the diode to limit a flow of current to the microcontroller.

6. The system of claim 1 wherein the microprocessor includes a compare circuit to determine whether the microcontroller has detected a valid LF field from the LF unmodulated signal.

7. The system of claim 6 wherein the compare circuit is operably coupled to the LF tank circuit to receive the LF field and to generate an output voltage based on the voltage level of the LF field.

8. The system of claim 6 wherein the compare circuit includes a comparator, the comparator includes a negative pin operably coupled to the LF tank circuit to receive the LF field and a positive pin operably coupled to a voltage reference that is a calibratable value.

9. A tire pressure monitoring (TPM) sensor in a vehicle that is capable of communicating with a trigger device that generates a low frequency (LF) signal unmodulated signal that is indicative of a trigger command, the sensor comprising:
an LF tank circuit adapted to receive the LF unmodulated signal; and
a microprocessor operably coupled to the LF tank circuit and adapted to detect the presence of the LF unmodulated signal and to transmit an RF output signal having tire pressure information in response to the trigger command without demodulating the LF unmodulated signal.

10. The sensor of claim 9 wherein the LF output signal further includes temperature and diagnostic information and the LF tank circuit is adapted to receive the LF signal at a predetermined frequency.

11. The sensor of claim 9 wherein the microprocessor comprises an application specific integrated circuit (ASIC).

12. The sensor of claim 11 further comprising an over-voltage protection circuit positioned between the LF tank circuit and the microprocessor to protect the microprocessor from an over-voltage condition caused by the LF unmodulated signal.

13. The sensor of claim 12 wherein the over-voltage protection circuit comprises a diode to limit voltage of the LF unmodulated signal and a resistor coupled to the diode to limit a flow of current to the microcontroller.

14. The sensor of claim 9 wherein the microprocessor includes a compare circuit to determine whether the microcontroller has detected a valid LF field from the LF unmodulated signal.

15. The sensor of claim 14 wherein the compare circuit is operably coupled to the LF tank circuit to receive the LF field and to generate an output voltage based on the voltage level of the LF field.

16. The sensor of claim 14 wherein the compare circuit includes a comparator, and the comparator includes a negative pin operably coupled to the LF tank circuit to receive the LF field and a positive pin operably coupled to a voltage reference that is a calibratable value.

17. A tire pressure monitoring (TPM) sensor in a vehicle that is capable of communicating with a trigger device that provides at least one low frequency (LF) modulated input signal, the sensor comprising:
an LF tank circuit adapted to receive the LF modulated input signal at a predetermined frequency;
a microprocessor operably coupled to the LF tank circuit and adapted to demodulate the LF modulated input signal, to decode data present in the LF modulated input signal and to generate an LF output signal in response to the decoded data; and
a compare circuit operably coupled to the LF tank circuit and adapted to receive the LF modulated input signal and to provide the LF modulated input signal to the microprocessor in response to the comparator determining that the LF modulated input signal is a valid signal.

18. The sensor of claim 17 wherein the microprocessor comprises an application specific integrated circuit (ASIC).

19. The sensor of claim 18 wherein the compare circuit is positioned in the microprocessor.

20. The sensor of claim 17 further comprising an over-voltage detection circuit coupled between the LF tank circuit and the microprocessor and an envelope detection circuit having first and second portions, wherein the first portion of the envelope detection circuit is positioned within the microcontroller and the second portion of the envelope detection circuit is coupled to the microcontroller.
